(19) United States
(12) Patent Application Publication
(10) Pub. No.: US 2016/0273387 A1
(43) Pub. Date: Sep. 22, 2016

(54) Method for Producing a Component

(71) Applicant: MTU Aero Engines AG, Muenchen (DE)

(72) Inventor: Dagobert GOEPFERT, Muenchen (DE)

(73) Assignee: MTU Aero Engines AG, Muenchen (DE)

(21) Appl. No.: 15/072,215

(22) Filed: Mar. 16, 2016

(30) Foreign Application Priority Data
Mar. 17, 2015 (DE) 10 2015 204 801.2

(51) Int. Cl. F01D 25/24

(52) U.S. Cl. CPC F01D 25/24; F05D 2230/18; F05D 2240/00

(57) ABSTRACT

A method for producing a component, particularly a component of a turbomachine, is disclosed. In an embodiment, the method includes the following process steps: a) producing a blank of a component by an additive production process or deposition of at least a first component element on a second component element by at least one additive production process for producing a blank of a component; b) setting a predefined roughness and/or quality of at least one section of a surface of the blank by vibratory grinding; and c) non-destructing testing of at least the section of the surface of the blank having a predefined roughness and/or quality by a penetration test, specifically a fluorescent penetrant test or dye penetrant test. A use of the method as well as components that are produced using the method are also disclosed.

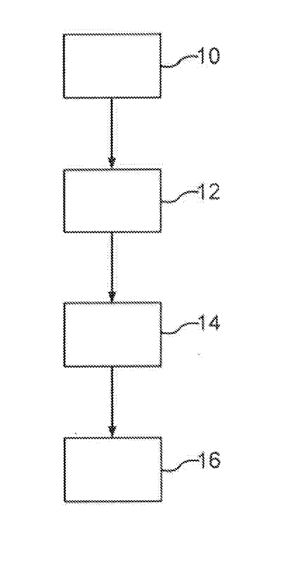

This application claims the priority of German Patent Application No. 10 2015 204 801.2 filed Mar. 17, 2015, the disclosure of which is expressly incorporated by reference herein.

### BACKGROUND AND SUMMARY OF THE INVENTION

The invention relates to a method for producing a component, particularly a component of a turbomachine. The invention also relates to using the method as well as the components that are made with the method.

Many methods are known for producing a component, particularly a component of a turbomachine. In particular, additive or generative production methods (referred to as rapid manufacturing and rapid prototyping methods respectively) are known, in which the component is built up layer-by-layer by means of powder bed-based additive production methods. Primarily metal components can be produced by laser or electron beam melting or sintering methods. In doing so, first at least one powdery component material is deposited in layers on a component platform in the region of a buildup or joining zone of the device. Subsequently, the component material is fused and/or sintered locally layer-by-layer, by delivering energy by means of at least one high-energy beam, for example an electron or laser beam, to the component material in the region of the buildup and joining zone. The high-energy beam is thereby controlled as a function of layer information of the respective component layer to be produced. After fusing and/or sintering, the component platform is lowered layer-by-layer by a predefined layer thickness. Thereafter, the mentioned steps are repeated until final completion of the component. From prior art, one knows particularly of generative production methods for producing components of a turbomachine, such as components of an aircraft engine or a gas turbine, for example the method described in DE 10 2009 051 479 A1 or a corresponding device for producing a component of a turbomachine. In this method, the layer-by-layer deposition of at least one powdery component material on a component platform in the region of a buildup and joining zone as well as the layer-by-layer and local fusing or sintering of the component material by means of energy supplied in the region of the buildup and assembly zone result in the production of a corresponding component. The energy is hereby supplied via laser beams, such as CO2 lasers, Nd:YAG lasers, Yb fiber lasers, as well as diode lasers, or by means of electron beams.

To inspect the quality of at least the surface regions of the additively produced component or component blank, it is first necessary to adjust the surface of the component, initially produced as a blank, to a suitable roughness or surface quality. Only then is it possible to successfully use non-destructive testing methods for crack tests. Methods for the non-destructive testing of workpiece surfaces are also known. In the so-called dye penetrant test, a penetrant is applied on a cleaned workpiece surface to be inspected. The capillary effect of fine surface cracks and pores favor the penetration of the penetrant in such recesses on the workpiece surface. Dye penetrant testing methods work with non-fluorescent dye solutions as penetrants (e.g., “red-white method”). In so-called fluorescent penetration testing, one works with a fluorescent penetrant. After a specified application time, excess penetrant is then washed off in an intermediary cleaning process. Then a developer is applied on the workpiece surface to be inspected. The developer promotes rewetting of the penetrant at a recess on the workpiece surface, where the penetrant is drawn out of the recess to the surface by the developer. In this way, possible irregularities in the workpiece surface, such as crack-like material separations, become clearly visible. The fluorescent penetration test is used particularly in aircraft, ship, and automobile manufacturing as well as other metalworking industries. However, other materials, such as ceramics, may be inspected for corresponding surface cracks and pores. To adjust the required roughness or surface quality, additively produced components and their blanks are subjected to wet blasting, since one can hereby decrease interfering background fluorescence in particular. However, this process is very work- and cost-intensive.

To obtain the desired strength characteristics for non-functional surfaces of the components or component blanks and to meet the drawing-based requirements in terms of surface roughness, these are also subjected to re-machining by means of tools having a defined cutting geometry (e.g., milling, lathing). This re-machining is done in the process steps after the crack testing.

However, the disadvantage in this known method is that on the one hand, to prepare the non-destructive testing method for the crack inspection, a work- and cost-intensive wet-blasting process is used and on the other, re-machining is required, at least of the non-functional surfaces of the components or component blanks.

The object of the present invention is to create a method for producing a component, particularly a component of a turbomachine, which allows for faster and more cost-effective production of the component. Another objective is to provide a component of a turbomachine, particularly a component of an aircraft engine, which can be produced faster and more cost-effectively.

A first aspect of the invention pertains to a method for producing a component, particularly a component of a turbomachine, including at least the following procedural steps in an embodiment:
a) producing a blank of the component by means of an additive production process or depositing at least a first component element on a second component element by means of at least one additive production process for producing a blank of the component;
b) adjusting a predefined roughness and/or quality of at least a section of a surface of the blank by means of vibratory grinding; and
c) non-destructive testing of at least the section of the surface of the blank with predefined roughness and/or quality by means of a penetration test, namely a fluorescent penetration test or dye penetration test.

The method according to the invention allows one to produce the component faster and more cost-effectively. For example, in preparing for crack testing, one can forego the work- and cost-intensive wet-blasting process. The surface roughness and/or surface quality of the blank or the component required for the crack test is achieved by means of the more cost-effective vibratory grinding. In addition, the intermediate step of the vibratory grinding advantageously results in one being able to forego at least the re-machining of the nonfunctional surfaces of the component to be produced, since the desired strength characteristics of non-functional surfaces can already be achieved by the smooth grinding.

In another advantageous embodiment of the method according to the invention, a heat treatment of the component blank produced by means of the additive method is performed prior to adjusting the predefined roughness and/or quality of at least the section of the surface of the blank according to process step b). In this way, internal stresses in the produced blank can be reduced or eliminated, which in turn ensures a higher quality of the component to be produced.

In another advantageous embodiment of the method according to the invention, the additive production method is a selective laser beam melting process, an electron beam melting process, a selective laser beam sintering process, an electron beam sintering process, or a cold gas injection process. Other additive or generative production methods are conceivable. The use of additive production methods allows rapid and cost-effective production of components, particularly components with complexly designed geometries. To produce the blank of the component according to process step a), one can thereby use at least one powdery or pasty, metallic, or ceramic component material.

In another advantageous embodiment of the method according to the invention, in process step b), the component blank is arranged and moved within a trough filled with grinding bodies or a work space of a smooth grinding device, by means of which respective surfaces of the blank can be abraded under the relative motion between the component and the grinding bodies. In doing so, it is sufficient that the components or component blanks are loosely placed into the trough or work space of the smooth grinding device, and move with the flow of the grinding bodies. However, it is also conceivable that the component is first secured in a clamping device, where the clamping device is then inserted with the component in the trough or work space of the smooth grinding device. The grinding bodies used may thereby consist of ceramic, steel, or corundum. Other materials are also conceivable for designing suitable grinding bodies.

In an advantageous embodiment of the method according to the invention and after the non-destructive testing of the blank, there follows according to process step c) a visual evaluation of the surface of the blank. In this way, possible untypical recesses or imperfections can be detected in the surface of the component. The visual evaluation can take place using a fluorescent penetrant by irradiating the component surface to be inspected with UV light. In this way and with the fluorescent penetrant, one can clearly identify filled or wetted recesses on the component surface. UV irradiation can make recesses in the component surface clearly and accurately visible.

In another advantageous design of the method according to the invention, at least the section of the component blank processed by means of vibratory grinding has an average roughness depth of R_{z}≦9.0 μm after vibratory grinding. The surface quality or surface roughness thereby advantageously meets the strength characteristics required of non-functional surfaces of certain components in jet engine construction and also the requirements to perform a successful crack test by means of penetration testing.

In another advantageous design of the method according to the invention, the component is a borescope boss or endoscope boss. By means of the method according to the invention, these components can be produced cost-effectively in the quality required. In particular, these may be borescope bosses that are used as part of a turbine housing of an aircraft engine.

According to a second aspect of the invention, the method according to the invention described above is used particularly for producing and overhauling components of a turbomachine, particularly components of a gas turbine. The features and advantages emerging from the implementation of the method according to the first aspect of the invention are found in the descriptions of the first aspect of the invention, wherein advantageous designs of the first aspect of the invention shall be considered advantageous designs of the second aspect of the invention and vice versa.

A third aspect of the invention relates to a component of a turbomachine, particularly a component of an aircraft engine produced according to a method as described above. Advantageously, this component can be produced faster and more cost-effectively compared to methods known from prior art, while meeting the required quality criteria.

In an advantageous design of the component according to the invention, the component has, at least in sections, a surface with an average roughness depth of R_{z}≦9.0 μm.

In this way and despite the faster and more cost-effective production of the component, the requirements pertaining to surface quality or surface roughness can be met in regard to the strength characteristics of the non-functional surfaces of the completed component, particularly of components in engine construction, by at least the non-functional surfaces of the component having an average roughness depth of R_{z}≦9.0 μm. The component according to the invention may involve a borescope boss or endoscope boss, particularly for use in aircraft engines.

The features and advantages resulting from using the method according to the first aspect of the invention appear in the descriptions of the first aspect of the invention, wherein advantageous designs of the first aspect of the invention shall be considered advantageous designs of the third and second aspects of the invention and vice versa.

Additional features of the invention emerge from the claims, the embodiments, and the drawing. The aforementioned features and feature combinations as well as the features and feature combinations mentioned in the embodiment below are not only usable in the respectively indicated combination, but also in other combinations or alone, without departing from the scope of the invention.

### BRIEF DESCRIPTION OF THE DRAWING

The FIGURE depicts a sequence diagram of a method according to the present invention for producing components.

### DETAILED DESCRIPTION OF THE DRAWING

The FIGURE depicts a sequence diagram of a method for producing a component, particularly a component of a turbomachine. In the depicted embodiment, the component is a borescope boss for use in an aircraft engine. Accordingly, in a first process step 10, a blank of the component is produced by means of an additive production procedure. The additive production procedure is thereby a selective laser beam melting, where metal powder is provided as the material for the component or the component blank, the metal powder being fused together layer-by-layer by means of laser energy into the design of the component or blank.

In a subsequent process step 12, the blank of the component is subjected to a heat treatment. The heat treatment serves to reduce or eliminate internal stresses in the component or component blank.

After the heat treatment of the component blank and in a subsequent process step 14, the roughness and/or quality of the surface of the blank is adjusted by means of vibratory grinding. In the depicted embodiment, the predefined roughness has an average roughness depth of R_{z}≦9.0 μm. To achieve this roughness, the component or component blank is placed into a trough, which is filled with abrasive bodies, of a vibratory grinding device. By means of the relative motion between the component and the abrasive bodies, the respective surfaces of the blank are abraded to the desired roughness or quality.

In a final process step 16, non-destructive testing of the surface of the blank takes place by means of penetration tests, specifically fluorescent penetrant testing or dye penetrant testing. Based on the penetrant testing, one can determine whether the component meets the quality requirements. If the component meets the quality requirements, there is also the possibility of passing on the functional surfaces of the component for re-machining. The non-functional surfaces of the component already fulfill the quality requirements, particularly the strength specifications of these regions, due to the set, predefined roughness, so that re-machining is no longer necessary here.

### LIST OF REFERENCE CHARACTERS

10 Process step
12 Process step
14 Process step
16 Process step

The foregoing disclosure has been set forth merely to illustrate the invention and is not intended to be limiting. Since modifications of the disclosed embodiments incorporating the spirit and substance of the invention may occur to persons skilled in the art, the invention should be constructed to include everything within the scope of the appended claims and equivalents thereof.

What is claimed is:

1. A method for producing a component, comprising the steps of:
producing a blank by an additive production method;
setting a predefined roughness and/or a quality of a surface of the blank by vibratory grinding; and
non-destructive testing of the surface by a penetration test after the vibratory grinding.

2. The method according to claim 1, further comprising the step of heat treating the blank prior to the step of setting.

3. The method according to claim 1, wherein the additive production method is a selective laser beam melting process, an electron beam melting process, a selective laser beam sintering process, an electron beam sintering process, or a cold gas injection process.

4. The method according to claim 1, wherein a powdery or a pasty metallic or ceramic material is used in the step of producing.

5. The method according to claim 1, wherein in the vibratory grinding, the blank is arranged and moved within a trough or a workspace which is filled with abrasive bodies of a vibratory grinding device such that relative motion occurs between the blank and the abrasive bodies.

6. The method according to claim 5, wherein the abrasive bodies are ceramic, steel, or corundum.

7. The method according to claim 1, further comprising the step of visually evaluating the surface after the step of non-destructive testing.

8. The method according to claim 7, wherein the step of visually evaluating includes irradiating the surface with ultraviolet light.

9. The method according to claim 1, wherein the surface has an average roughness depth of R_{z}≦9.0 μm after the vibratory grinding.

10. The method according to claim 1, wherein the component is a borescope boss or endoscope boss.

11. The method according to claim 1, wherein the component is a component of a turbomachine.

12. The method according to claim 1, wherein the penetration test is a fluorescent penetrant test or dye penetrant test.

13. A use of a method according to claim 1 to produce or overhaul a component of a turbomachine.

14. The use according to claim 13, wherein the turbomachine is an aircraft engine.

15. A component of a turbomachine produced according to the method of claim 1.

16. The component according to claim 15, wherein the turbomachine is an aircraft engine.

17. The component according to claim 15, wherein the surface has an average roughness depth of R_{z}≦9.0 μm.

18. The component according to claim 15, wherein at least non-functional surfaces of the component have an average roughness depth of R_{z}≦9.0 μm.

19. The component according to claim 15, wherein the component is a borescope boss or endoscope boss.
